(19) United States
(12) Patent Application Publication
(10) Pub. No.: US 2009/0025702 A1
(43) Pub. Date: Jan. 29, 2009

(54) Food ingredient holding and warming accessory for use with commercial griddles and charbroilers

(76) Inventors: Triandafilos Hatjopoulos, Uxbridge, MA (US); George Hatjopoulos, Blackstone, MA (US)

Correspondence Address: Russ Weinzimmer, 614 Nashua St. #204, Milford, NH, 03055, US

(21) Appl. No.: 11/895,703

(22) Filed: Aug. 25, 2007

Related U.S. Application Data
(63) Continuation-in-part of application No. 11/880,851, filed on Jul. 24, 2007.

(51) Int. Cl. A47J 37/06; A47J 36/00

(52) U.S. Cl. 126/14; 220/573.1

(57) ABSTRACT

A food ingredient holding accessory is disclosed that is attachable to a commercial griddle and able to contain butter, sauces, spices, etc, in a location that is readily accessible to a grill cook, does not taking up space on the cooking surface, avoids cooking splatter, and avoids heat damage to the food ingredients. One aspect of the invention is attachable to a staging feature on top of a barrier that runs along the backsplash of the griddle, while Another aspect is directly attachable to the backsplash or to a side splash of the griddle. In preferred embodiments, the accessory is made from stainless steel, comprises a plurality of holding compartments for holding food ingredients, ranges in height from 8″ to 17″ above the cooking surface, and/or includes a removable tray insert that can allow a holding compartment to be used as a double boiler.

### CROSS-REFERENCES TO RELATED APPLICATIONS

This application is a continuation in part entitled to the benefit of U.S. patent application Ser. No. 11/880,851, entitled “APPARATUS FOR USE WITH COMMERCIAL GRIDDLES AND CHARBROILERS FOR IMPROVED SAFETY, ORGANIZATION, AND EFFICIENCY”, filed Jul. 24, 2007, herein incorporated by reference.

### FIELD OF THE INVENTION

This invention generally relates to commercial cooking equipment, and particularly to accessories for commercial griddles and charbroilers.

### BACKGROUND OF THE INVENTION

A griddle (sometimes referred to as a grill) or a charbroiler is often the first piece of equipment purchased for a new restaurant because it is an essential focal point for activity in the kitchen. Owners of restaurants, hotels, hospitals, military bases, cruise ships, colleges, etc all use a griddle or a charbroiler to cook many of their offerings.

Commercially available griddles and charbroilers provide a large cooking surface to efficiently cook food. Grill cooks often increase their efficiency by placing a grill butter pan, spice cups, a sauce water bath, and/or other food ingredient containers on the grill cooking surface, so as to have these food ingredients conveniently at hand whenever needed. However, placing food ingredient containers on a grill surface takes up valuable surface area intended for cooking food. Furthermore, cooking on a griddle and/or a charbroiler inevitably results in food ejectile residue, including hot fat splatter, oil splatter, and food particles, and this residue can fall into open food ingredient containers, leading to degradation of the food quality and even to health risks. Finally, placing food ingredient containers directly on a cooking surface can lead to overheating and even damaging of the ingredients, rendering them low in quality or completely unusable.

### SUMMARY OF THE INVENTION

A food ingredient holding accessory is disclosed that is able to contain one or more food ingredients and is attachable to a commercial griddle or charbroiler, such that the food ingredients are positioned within easy reach of a grill cook using the griddle or charbroiler, and such that the food ingredients are positioned at a height above the cooking surface of the griddle or charbroiler that is sufficient to prevent contamination of the food ingredients by ejectile residue from the cooking surface and is also sufficient to prevent heating damage to the food ingredients. The food ingredient holding accessory comprises a container that includes at least one holding compartment that is able to contain a food ingredient such as grill butter, a mix of cooking spices, or a sauce, for example, and in preferred embodiments it comprises a plurality of such holding compartments. In preferred embodiments, the container is made from stainless steel, and is positioned at least 8 inches above the cooking surface, and/or is positioned no more than 17 inches above the cooking surface. In further preferred embodiments, the container is positioned so that food ingredients such as melted butter are kept warm while at the same time not being overheated, while in still further preferred embodiments at least one removable tray insert is included that allows at least one of the holding compartments to be used as a double boiler for warming delicate ingredients such as hollandaise sauce or béarnaise sauce.

One aspect of the invention is intended for use with a griddle or charbroiler that includes a barrier running along the backsplash of the griddle or charbroiler, wherein the barrier extends vertically at least 8 inches above the cooking surface and has a staging feature extending along the topmost portion of the barrier. In this aspect of the invention, the food ingredient holding accessory includes an attachment mechanism that attaches the container to the staging feature. In preferred embodiments, the food ingredient holding accessory can be placed at any of a plurality of locations horizontally along the staging feature, or can be continuously moved or slid along the staging feature while attached.

In another aspect of the invention, an attachment mechanism is used to attach the container directly to the backsplash or side splash guard of a commercial griddle or charbroiler. In preferred embodiments, the attachment mechanism is adjustable such that the food ingredient holding accessory can be flexibly positioned above the cooking surface.

In preferred embodiments, the food ingredient holding accessory is made from stainless steel. While other materials can be used, such as aluminum, cast iron, copper, and the like, they are more costly. Stainless steel is also preferable because it is easy to clean, and is commonly used in commercial kitchens. Stainless steel is also a readily available material which can be readily shaped into various embodiments.

### BRIEF DESCRIPTION OF THE DRAWINGS

The invention will be more fully understood by reference to the detailed description, in conjunction with the following figures, wherein:

FIG. 1 is a perspective view from the side of a preferred embodiment that comprises a container with one holding compartment and an attachment mechanism that is fixed to the side of the container near the bottom of the container;

FIG. 2 is a perspective view from the rear of the preferred embodiments of FIG. 1;

FIG. 3 is a perspective view from the front of the preferred embodiment of FIG. 1 shown attached to a staging feature on top of a barrier extending along the backsplash of a commercial griddle;

FIG. 4 presents a rear side view and a perspective view of the preferred embodiment of FIG. 1 attached to a staging feature on top of a barrier, wherein the staging feature is shaped like an inverted “L”;

FIG. 5 presents a side view and a perspective view of a preferred embodiment attached to a staging feature on top of a barrier, wherein the staging feature is shaped like an inverted “L,” and wherein the preferred embodiment includes a container with one holding compartment and an attachment mechanism that is fixed to the side of the container near the top of the container;

FIG. 6 is a perspective view from the front of a preferred embodiment similar to the preferred embodiment of FIG. 5, but further comprising a removable tray insert that can allow the container to be used as a double boiler;

FIG. 7 is a perspective view from the front of a preferred embodiment in which the container includes a plurality of holding compartments; and

FIG. 8 is a perspective view of a preferred embodiment wherein the attachment mechanism is adapted for attachment to a backsplash or side splash guard of a commercial griddle or charbroiler, and wherein the attachment mechanism is further adapted to allow flexible adjustment of the positioning of the container above the cooking surface while the attachment mechanism is attached to the backsplash.

### DETAILED DESCRIPTION OF PREFERRED EMBODIMENTS

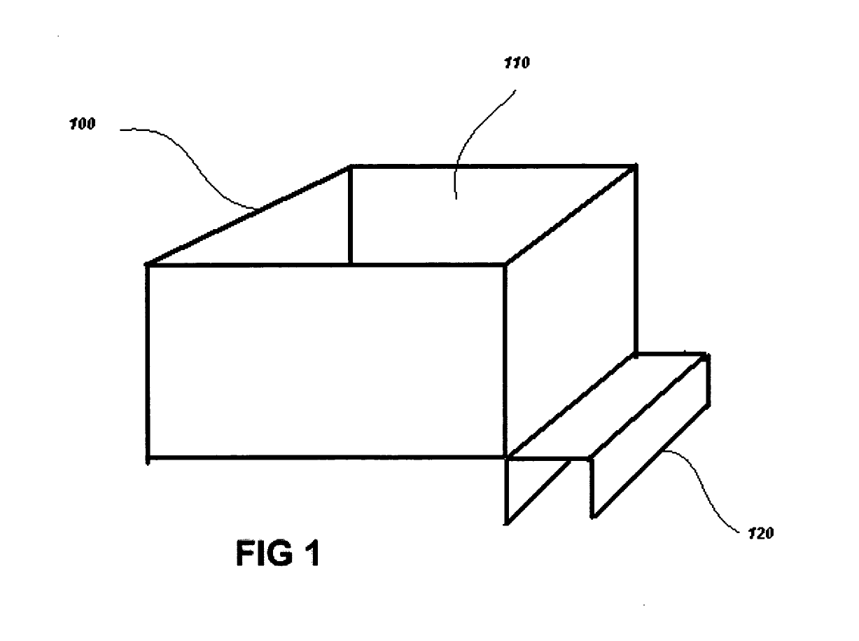

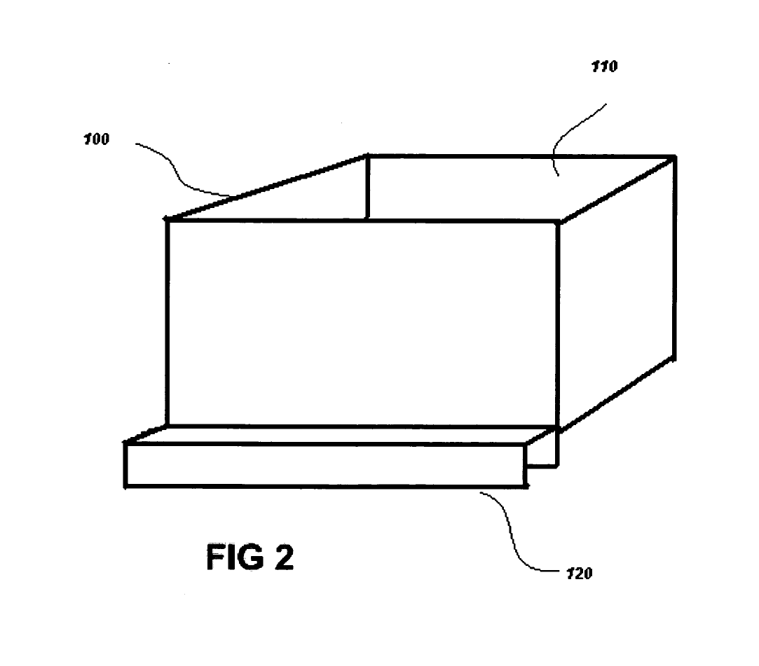

FIG. 1 and FIG. 2 show the same preferred embodiment from the side and from the rear, respectively. Referring to FIG. 1 and FIG. 2, in a preferred embodiment the food ingredient holding accessory comprises a container 100 that includes a single holding compartment 110. The holding compartment is open at the top, and is suitable for holding a food ingredient such as grill butter, shortening, a mix of spices, a sauce, or another, similar food ingredient. The embodiment shown in FIG. 1 and FIG. 2 is intended for use with a commercial griddle or charbroiler that is equipped with a barrier extending along its backsplash and extending upwardly with respect to the cooking surface, wherein there is a staging feature extending along the topmost portion of the barrier with an essentially rectangular cross section. The attachment mechanism 120 in the embodiment of FIG. 1 and FIG. 2 is a bracket that is designed to rest on the staging feature so as to hold the container 100 in a stable, vertical position while allowing the container 100 to be moved horizontally along the staging feature.

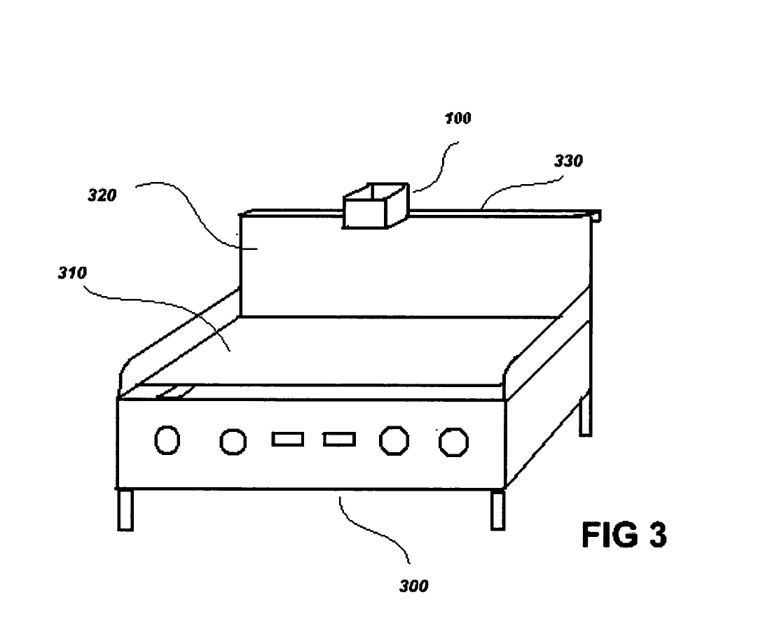

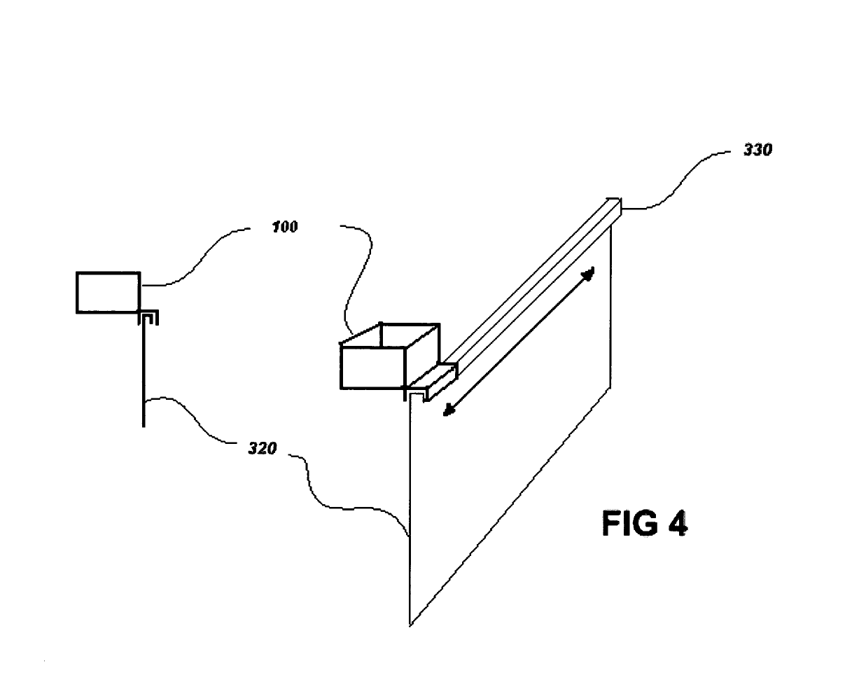

FIG. 3 shows the preferred embodiment of FIG. 1 and FIG. 2 attached to a commercial griddle 300 that comprises a cooking surface 310, a barrier 320 extending along its backsplash (not shown), and a staging feature 330 extending along the topmost portion of the barrier. The container 100 of the preferred embodiment is supported by the attachment mechanism (120 in FIG. 1 and FIG. 2) that rests on top of the staging feature 330, such that the container can be moved horizontally along the staging feature 330 while being maintained in an essentially vertical orientation. This can be more clearly seen in FIG. 4, which presents views of the container 100 of the preferred embodiment of FIG. 1, FIG. 2, and FIG. 3 from the side and from the rear, and shows the attachment of the invention to the staging feature 330 of the barrier 320, as well as the ability of the container 100 to slide along the length of the staging feature 330.

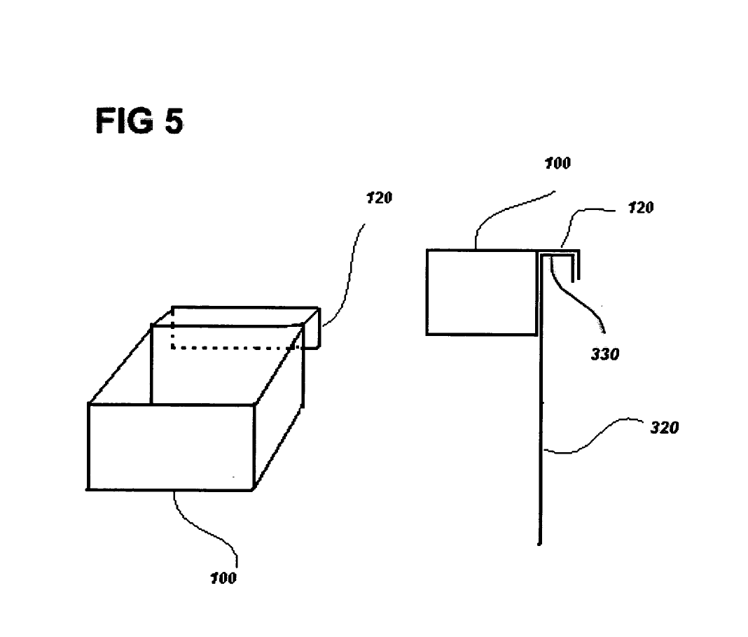

FIG. 5 includes both a perspective front view and a side view of a preferred embodiment that is similar to the preferred embodiment of FIG. 1, FIG. 2, FIG. 3, and FIG. 4, except that the attachment mechanism 120 is fixed to the container 100 near the top of the container 100. This provides a more stable mounting of the container 100 to the staging feature 330 of the barrier 320, since the center of mass of the container 100 hangs below the point of attachment and the side of the container 100 rests against the barrier 320.

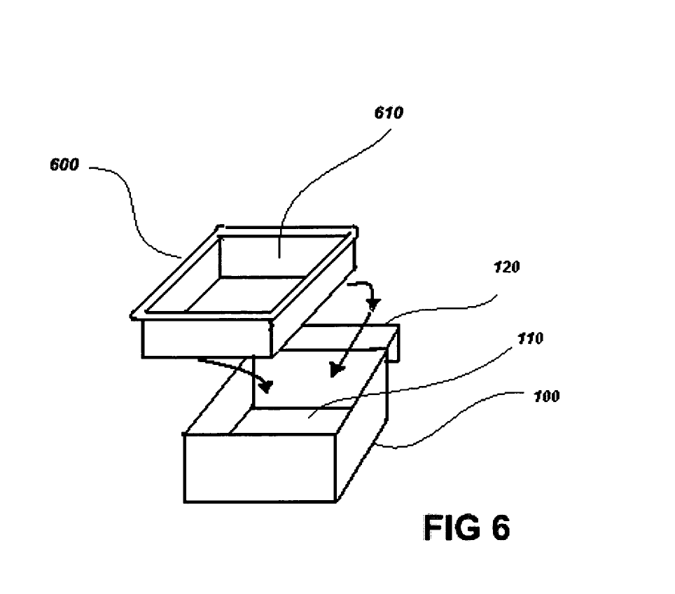

FIG. 6 illustrates a preferred embodiment that is similar to the preferred embodiment of FIG. 5, except that the invention further comprises a removable tray insert 600 that can be placed into the holding compartment 110 of the container 100. The tray insert 600 allows the container 100 to be used as a double boiler, or “bain marie,” wherein water in the holding compartment 110 is warmed by heat rising up from the cooking surface of the griddle or charbroiler, and wherein a delicate food ingredient such as a hollandaise sauce or béarnaise sauce is warmed in the interior 610 of the tray insert 600, which is placed into the holding compartment 110 such that it rests on the upper rim of the holding compartment and makes contact with the water but not with the bottom of the holding compartment.

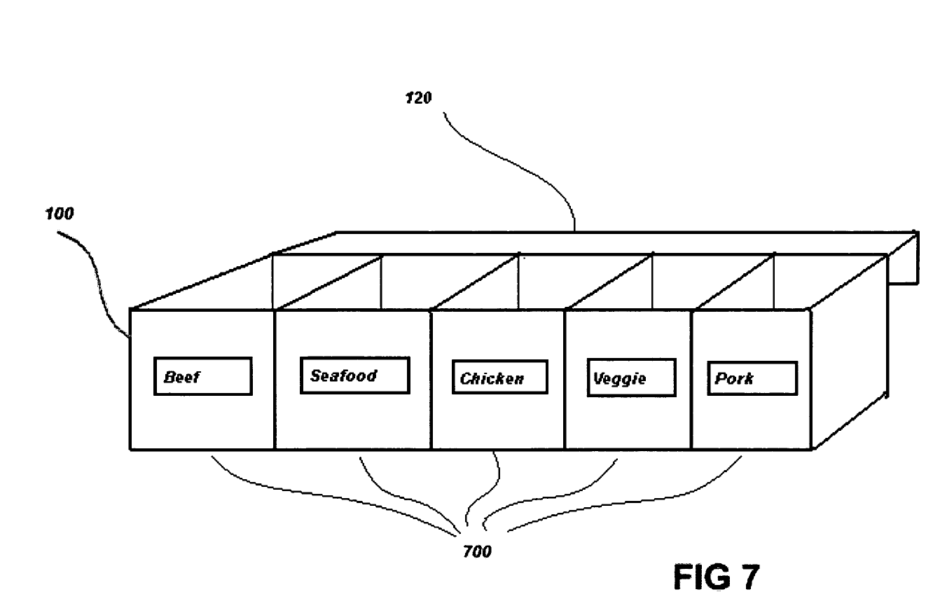

FIG. 7 illustrates a preferred embodiment in which the container 100 includes a plurality of holding compartments 700, which in FIG. 7 have been labeled as being intended to hold spice blends appropriate for different varieties of meat and vegetables. The container 100 is fixed to an attachment mechanism 120 that is similar to the attachment mechanism of FIG. 5 and FIG. 6, except that it is longer, so as to accommodate the plurality of holding compartments 700.

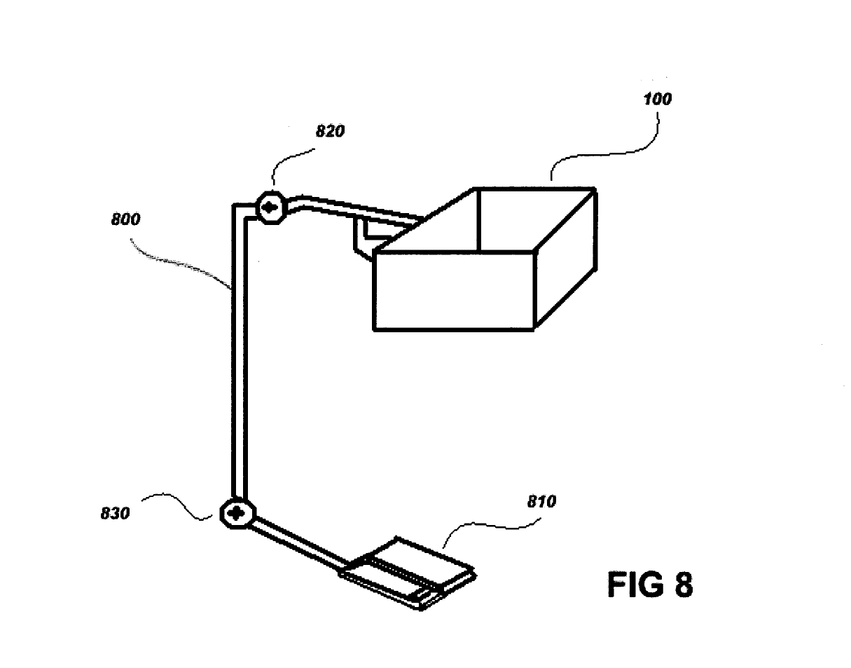

FIG. 8 illustrates a preferred embodiment of the invention that is intended for attachment directly to the backsplash or side splash guard of a commercial griddle or charbroiler, in the event that the griddle or charbroiler is not equipped with a barrier and/or staging feature as described above. In this preferred embodiment, the container 100 is supported by an adjustable support arm 800 that includes a clamping mechanism 810 for attachment to the backsplash or side splash guard. The adjustable support arm 800 includes two pivots 820, 830, that allow the position of the container 100 to be flexibly adjusted relative to the cooking surface, so that the container receives the optimal amount of heat from the cooking surface of the griddle or charbroiler and so that the container is conveniently accessible to a cook using the griddle or charbroiler.

Other modifications and implementations will occur to those skilled in the art without departing from the spirit and the scope of the invention as claimed. Accordingly, the above description is not intended to limit the invention except as indicated in the following claims.

What is claimed is:

1. A food ingredient holding accessory for use with a commercial griddle, the commercial griddle having a cooking surface, a backsplash, a barrier extending along the backsplash and extending upwardly with respect to the cooking surface, and a staging feature extending along the topmost portion of the barrier, the staging feature being at least 8 inches above the cooking surface, the food ingredient holding accessory comprising:
a container, open at the top, having at least one holding compartment that is able to contain a food ingredient; and
an attachment mechanism that is able to attach the container to the staging feature of the barrier, the attachment mechanism being able to support the container in an essentially upright position.

2. The food ingredient holding accessory of claim 1, wherein the attachment mechanism is adapted to attach the container to an accessory staging feature that has a cross-section shaped like an inverted squared “J”.

3. The food ingredient holding accessory of claim 1, wherein the attachment mechanism is adapted to attach the container to an accessory staging feature that has a cross-section shaped like an inverted “L”.

4. The food ingredient holding accessory of claim 1, wherein the attachment mechanism is adapted to attach the container to an accessory staging feature that has a cross-section shaped like a straight vertical wall having a thin, smooth, flat top.

5. The food ingredient holding accessory of claim 1, wherein the food ingredient holding accessory is made of stainless steel.

6. The food ingredient holding accessory of claim 1, wherein the attachment mechanism is adapted to allow the container to be attached to any of a plurality of positions on the staging feature.

7. The food ingredient holding accessory of claim 6, wherein the attachment mechanism is configured to allow the container to be moved horizontally in an essentially continuous manner along the staging feature while remaining attached to the staging feature.

8. The food ingredient holding accessory of claim 1, wherein attaching the attachment mechanism to the staging feature places the container at a height relative to the cooking surface sufficient to warm the contents of the container without damaging the contents of the container.

9. The food ingredient holding accessory of claim 1, wherein attaching the attachment mechanism to the staging feature places the container no more than 17 inches above the cooking surface of the commercial griddle.

10. The food ingredient holding accessory of claim 1, further comprising at least one removable tray insert that can be placed into at least one holding compartment such that it rests on and is supported by the rim of the holding compartment and extends into the interior of the holding compartment without touching the bottom of the holding compartment, thereby allowing the at least one removable tray insert and the at least one holding compartment to function together as a double boiler for warming a delicate food ingredient contained in the at least one removable tray insert.

11. The food ingredient holding accessory of claim 1, wherein the container includes a plurality of holding compartments.

12. A food ingredient holding accessory for use with a commercial griddle, the commercial griddle having a cooking surface and a splash barrier that is at least one of a backsplash and a side splash guard, the food ingredient holding accessory comprising:
a container, open at the top, having at least one holding compartment that is able to contain a food ingredient; and
an attachment mechanism that is able to attach the container to the splash barrier of the griddle, the attachment mechanism being able to support the container in an essentially upright position at least 8 inches above the cooking surface of the griddle.

13. The food ingredient holding accessory of claim 12, wherein the food ingredient holding accessory is made of stainless steel.

14. The food ingredient holding accessory of claim 12, wherein the attachment mechanism is adapted to allow the location of the container relative to the cooking surface of the griddle to be to adjusted to any of a plurality of positions.

15. The food ingredient holding accessory of claim 14, wherein the attachment mechanism is configured to allow the container to be adjusted continuously through a range of locations relative to the cooking surface of the griddle.

16. The food ingredient holding accessory of claim 15, wherein the attachment mechanism is configured to allow the height of the container above the cooking surface of the griddle to be continuously adjusted over a range that extends from a minimum of not more than 8 inches to a maximum of not less than 17 inches.

17. The food ingredient holding accessory of claim 12, wherein the attachment mechanism is able to place the container at a height relative to the cooking surface sufficient to warm the contents of the container without damaging the contents of the container.

18. The food ingredient holding accessory of claim 12, further comprising at least one removable tray insert that can be placed into at least one holding compartment such that it rests on and is supported by the rim of the holding compartment and extends into the interior of the holding compartment without touching the bottom of the holding compartment, thereby allowing the at least one removable tray insert and at least one holding compartment to function together as a double boiler for warming a delicate food ingredient contained in the at least one removable tray insert.

19. The food ingredient holding accessory of claim 12, wherein the container includes a plurality of holding compartments.
